(19) United States
(12) Patent Application Publication
(10) Pub. No.: US 2015/0109536 A1
(43) Pub. Date: Apr. 23, 2015

(54) DISPLAY APPARATUS AND DISPLAY METHOD USING THE SAME

(71) Applicant: Delta Electronics, Inc., Taoyuan Hsien (TW)

(72) Inventors: Tzu-Wei SU, Taoyuan Hsien (TW); Douglas BOUDON, Taoyuan Hsien (TW); Benjamin STEWART, Taoyuan Hsien (TW)

(73) Assignee: Delta Electronics, Inc., Taoyuan Hsien (TW)

(21) Appl. No.: 14/056,090

(22) Filed: Oct. 17, 2013

(51) Int. Cl. H04N 5/74

(52) U.S. Cl. CPC H04N 5/7458
USPC 348/745

(57) ABSTRACT

An aspect of the present invention provides a display apparatus, includes a plurality of projectors, at least one aspherical mirror, at least one image capture device, and an image correction system. Each of the projectors is configured to provide a sub image. The sub images are projected onto a screen to form a main image on the screen, and adjacent two of the sub images on the screen have an overlapping portion. The image capture device is configured to capture at least one mirror image on the aspherical mirror. The mirror image originates from the sub images. The image correction system is configured to correct pixel positions of the sub images on the screen according to the mirror image captured by the image capture device.

### BACKGROUND

1. Technical Field

The present disclosure relates to a display apparatus.

2. Description of Related Art

Blended images using multiple projectors has become a practical solution in the displaying market. Various methods have been applied to define blended regions of the bended images, such as “point and click” mouse solutions to physically set boundary areas, and camera methods for obtaining optical feedback information for the blending software.

The optical camera method requires less user input since the edges of a display area can be seen by the camera and the projected image is not blocked by the user. But to date, the camera needs to be mounted somewhere in front of the display. A distance of 12 ft to 15 ft is typical but large area displays may need more distance to capture the entire display area or the camera must be outfitted with a more expensive wide angle lens.

In a newly developed blended system, extreme short throw (EST) projectors are used so that a user can approach the screen and not block the projected image. This is different from which typically has been used-long throw projectors mounted in the rear of the room. In these systems the blending camera are also mounted in the rear of the room, near the projectors.

In the EST type system, it is also desirable to mount the camera near the projectors. However, since it is also desirable to use a low cost, off the shelf web camera, a problem occurs if the camera cannot have a very wide angle lens. Modifying the web cam with a wide angle lens is cost prohibitive.

### SUMMARY

An aspect of the present invention provides a display apparatus, includes a plurality of projectors, at least one aspherical mirror, at least one image capture device, and an image correction system. Each of the projectors is configured to provide a sub image. The sub images are projected onto a screen to form a main image on the screen, and adjacent two of the sub images on the screen have an overlapping portion. The image capture device is configured to capture at least one mirror image on the aspherical mirror. The mirror image originates from the sub images. The image correction system is configured to correct pixel positions of the sub images on the screen according to the mirror image captured by the image capture device.

In one or more embodiments, a plurality of the aspherical mirrors are configured to respectively reflect the sub images onto the screen.

In one or more embodiments, each of the projector is disposed between the screen and at least one of the aspherical mirrors.

In one or more embodiments, the image capture device is disposed between two of the projectors, and the image capture device is configured to capture the mirror image on every aspherical mirror in sequence.

In one or more embodiments, a plurality of the image capture devices are configured to respectively capture the mirror images on the aspherical mirrors.

In one or more embodiments, the aspherical mirror is configured to reflect at least the overlapping portion to the image capture device.

In one or more embodiments, the display apparatus further includes a plurality of projecting mirrors configured to respectively reflect the sub images onto the screen.

In one or more embodiments, each of the projectors is disposed between the screen and one of the projecting mirrors.

In one or more embodiments, the shape of the aspherical mirror is substantially the same as the shape of each of the projecting mirrors.

In one or more embodiments, the aspherical mirror is disposed between two of the projecting mirrors.

In one or more embodiments, the image capture device is disposed between two of the projectors.

In one or more embodiments, the image capture device is a web cam.

An aspect of the present invention provides a display method. A plurality of sub images are projected onto a screen to form a main image on the screen. Adjacent two of the sub images on the screen have an overlapping portion. At least one mirror image on at least one aspherical mirror is captured. The mirror image originates from the sub images. The pixel positions of the sub images on the screen are corrected according to the mirror image.

In one or more embodiments, the step of projecting the sub images onto the screen includes the following steps. The sub images are respectively provided to a plurality of the aspherical mirrors. The sub images are respectively reflected onto the screen by the aspherical mirrors. The step of capturing the mirror image includes capturing the mirror image on every aspherical mirror in sequence.

In one or more embodiments, the step of projecting the sub images onto the screen includes the following steps. The sub images are respectively provided to a plurality of the aspherical mirrors. The sub images are respectively reflected onto the screen by the aspherical mirrors. The step of capturing the mirror image includes respectively capturing a plurality of the mirror images on the aspherical mirrors.

In one or more embodiments, the step of capturing the mirror image includes the following steps. At least the overlapping portion is reflected to the image capture device by the aspherical mirror. The mirror image on the aspherical mirror is captured.

### BRIEF DESCRIPTION OF THE DRAWINGS

FIG. 1 is a schematic diagram of a display apparatus according to a first embodiment of the present invention;

FIG. 2 is a top view of the display apparatus of FIG. 1;

FIG. 3 is a schematic diagram of the sub images on the screen of FIG. 1 before the pixel position corrections;

FIG. 4 is a schematic diagram of a display apparatus according to a second embodiment of the present invention;

FIG. 5 is a top view of the display apparatus of FIG. 4;

FIG. 6 is a schematic diagram of a display apparatus according to a third embodiment of the present invention; and

FIG. 7 is a top view of the display apparatus of FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

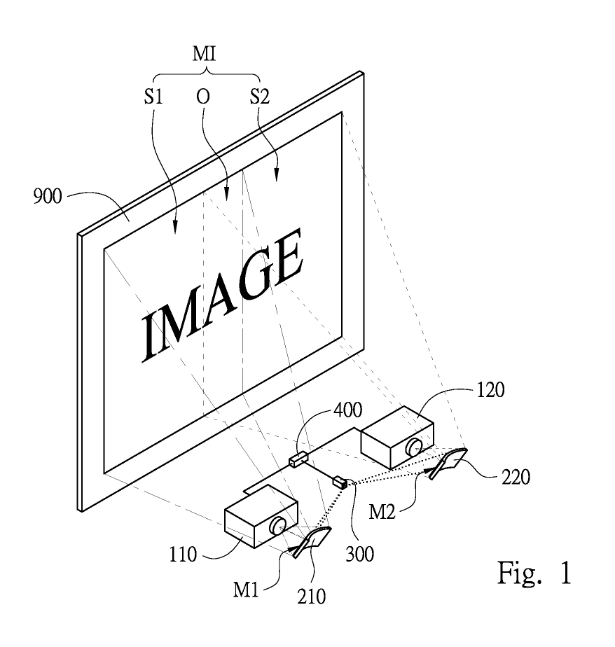

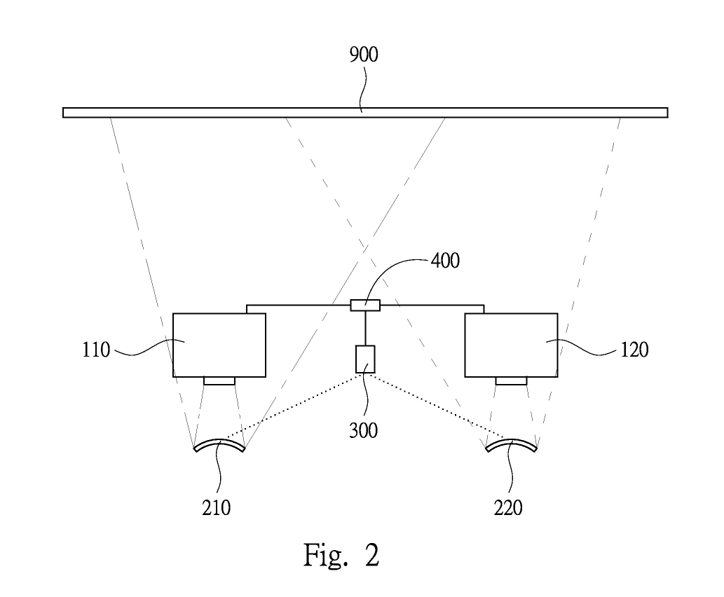

FIG. 1 is a schematic diagram of a display apparatus according to a first embodiment of the present invention, and FIG. 2 is a top view of the display apparatus of FIG. 1. Reference is made to FIG. 1 and FIG. 2. The display apparatus includes a plurality of projectors, for example, projectors 110 and 120, at least one aspherical mirror 210 (or 220), an image capture device 300, and an image correction system 400. Each of the projectors is configured to provide a sub image, for example, sub image S1 (or S2). The sub images S1 and S2 are projected onto the screen 900 to form a main image MI on the screen 900. Adjacent two of the sub images S1 and S2 have an overlapping portion O. The image capture device 300 is configured to capture at least one mirror image, for example, mirror image M1 (or M2) on the aspherical mirror 210 (or 220), wherein the mirror image originates from the sub image. The image correction system 400 is configured to correct pixel positions of the sub images on the screen 900 according to the mirror image captured by the image capture device 300. Instead of capturing the main image MI on the screen 900, the image capture device 300 in this embodiment captures at least one of the mirror images M1 and M2, such that the image capture device 300 can be a low cost camera.

In greater detail, in this embodiment, the display apparatus includes the projectors 110 and 120, and two aspherical mirrors 210 and 220. The projector 110 is configured to provide the sub image S1, and the projector 120 is configured to provide the sub image S2. The aspherical mirror 210 is configured to reflect the sub image S1 onto the screen 900, and the aspherical mirror 220 is configured to reflect the sub image S2 on the screen 900. The sub image S1 impinges on the aspherical mirror 210 to generate the mirror image M1 on the aspherical mirror 210. The sub image S1 is then reflected by the aspherical mirror 210 and is projected onto the screen 900. The sub image S2 impinges on the aspherical mirror 220 to generate the mirror image M2 on the aspherical mirror 220. The sub image S2 is then reflected by the aspherical mirror 220 and is projected onto the screen 900. The sub images S1 and S2 form the main image MI with the overlapping portion O on the screen 900. No corrections have been made to the sub images S1 and S2 yet. In other words, discontinuous edges (not shown) of the main image MI may exist at the overlapping portion O. To eliminate the discontinuous edges, the image capture device 300 can be disposed between the projectors 110 and 120 and capture the mirror images M1 and M2 on the aspherical mirrors 210 and 220 in sequence. For example, the image capture device 300 may capture the mirror image M1 before or after capturing the mirror image M2. The mirror images M1 and M2 captured by the image capture device 300 are then sent to the image correction system 400. The image correction system 400 corrects the pixel positions of the sub images S1 and S2 on the screen 900 according to the mirror images M1 and M2, such that the sub images S1 and S2 can be aligned.

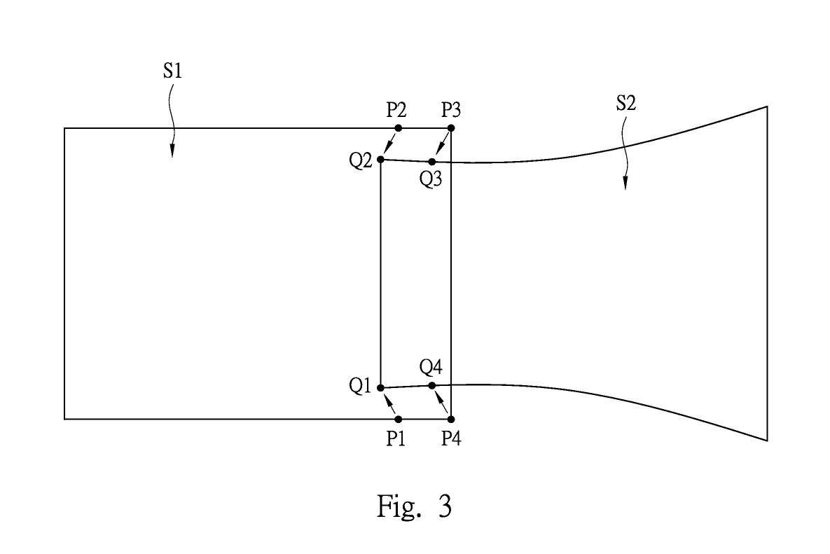

Reference is made to FIG. 1 and FIG. 3. FIG. 3 is a schematic diagram of the sub images S1 and S2 on the screen 900 of FIG. 1 before the pixel position corrections. In greater detail, the image capture device 300 respectively captures the sub images S1 and S2 and sends them to the image correction system 400 before the pixel position corrections. The image correction system 400 can reconstruct projecting positions of the sub images S1 and S2 on the screen 900 and analyzes the pixel positions of the sub images S1 and S2. For example, the pixel positions Q1, Q2, Q3, Q4 of the sub image S2 and the pixel positions P1, P2, P3, P4 of the sub image S1 on the screen 900 are all analyzed. To correct the pixel positions of the sub images S1 and S2, the pixel position P1 can be aligned to the pixel position Q1, the pixel position P2 can be aligned to the pixel position Q2, the pixel position P3 can be aligned to the pixel position Q3, and the pixel position P4 can be aligned to the pixel position Q4. The image correction system 400 may feedback orders to the projectors 110 and 120 to adjust projecting angles of the sub images S1 and S2 respectively projecting to the aspherical mirrors 210 and 220, such that the sub images S1 and S2 can be formed as the shape shown in FIG. 1. However, the scope of the claimed invention should not be limited in this respect.

Reference is made back to FIG. 1 and FIG. 2. In this embodiment, the image capture device 300 captures the mirror images M1 and M2 on the aspherical mirrors 210 and 220 rather than the main image MI on the screen 900, such that the image capture device 300 do not need to take a wide range image as the main image MI. To take the wide range image, the image capture device 300 need to be a wide-angle camera which may cost too high, or a camera disposed far away from the screen 900 which may block the views of users. However, since the sizes of the mirror images M1 and M2 are much smaller than the main image MI, the image capture device 300 in this embodiment can be a camera with low cost, such as a web cam.

In one or more embodiment, the projectors 110 and 120 can be extreme short throw (EST) projectors, such that the projector 110 is disposed between the screen 900 and the aspherical mirror 210, and the projector 120 is disposed between the screen 900 and the aspherical mirror 220. The sub images S1 and S2 with near rectangular shaped on the screen 900 can be produced by the aspherical mirrors 210 and 220, respectively, and the aspherical mirrors 210 and 220 can further decrease the distortion of the sub images S1 and S2.

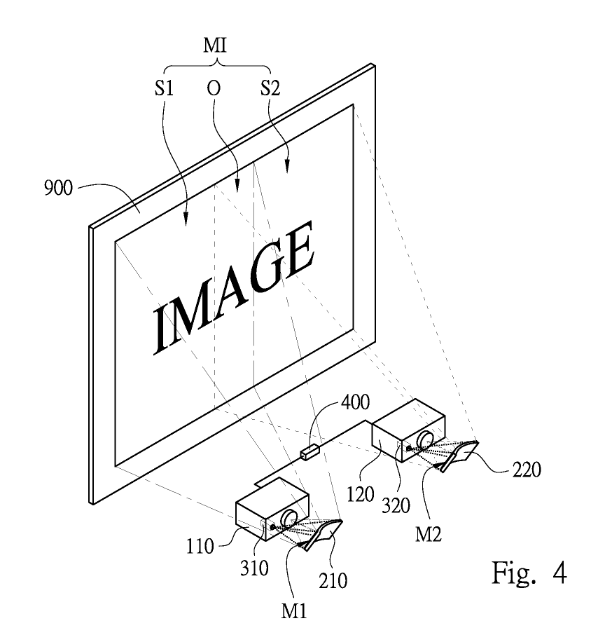

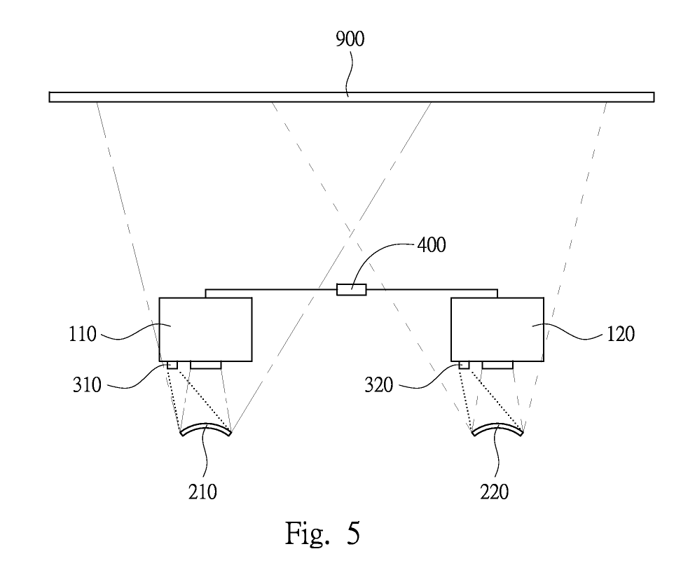

FIG. 4 is a schematic diagram of a display apparatus according to a second embodiment of the present invention, and FIG. 5 is a top view of the display apparatus of FIG. 4. Reference is made to FIG. 4 and FIG. 5. The differences between the display apparatuses of the second embodiment and the first embodiment are the number and the positions of the image capture devices. In this embodiment, two image capture devices 310 and 320 are disposed in the projectors 110 and 120, respectively. The image capture device 310 is configured to capture the mirror image M1 on the aspherical mirror 210, and the image capture device 320 is configured to capture the mirror image M2 on the aspherical mirror 220.

In greater detail, the projector 110 provides the sub image S1 to the aspherical mirror 210 to generate the mirror image M1, and the projector 120 provides the sub image S2 to the aspherical mirror 220 to generate the mirror image M2. The sub images S1 and S2 are then respectively reflected by the aspherical mirrors 210 and 220 and are projected onto the screen 900 to form the main image MI. The image capture device 310 captures the mirror image M1 on the aspherical mirror 210, and the image capture device 320 captures the mirror image M2 on the aspherical mirror 220. The mirror images M1 and M2 respectively captured by the image capture devices 310 and 320 are then sent to the image correction system 400. The image correction system 400 corrects the pixel positions of the sub images S1 and S2 on the screen 900 according to the mirror images M1 and M2, such that the sub images 51 and S2 can be aligned. It should be noticed that although in this embodiment, the image capture devices 310 and 320 are respectively disposed in the projectors 110 and 120, the scope of the claimed invention should not be limited in this respect. An embodiment falls within the scope of the claimed invention if the image capture devices 310 and 320 can capture the mirror images M1 and M2, respectively. As to other relevant structures and process details are all the same as the embodiment shown in FIG. 1 and FIG. 2, and, therefore, these are not repeated hereinafter.

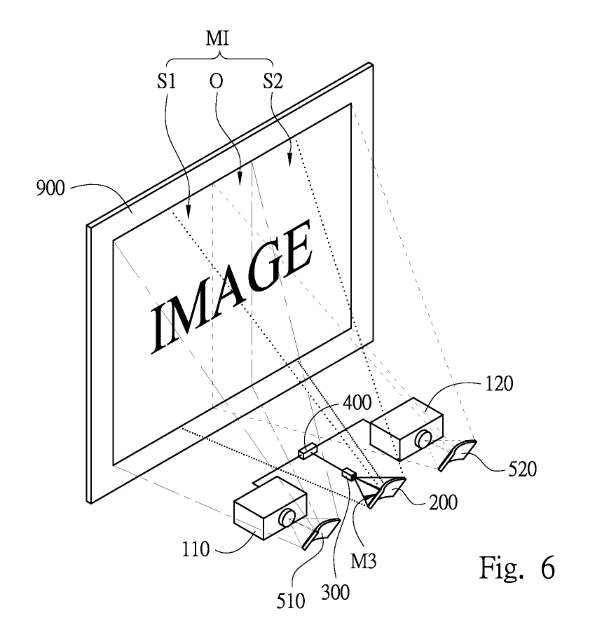

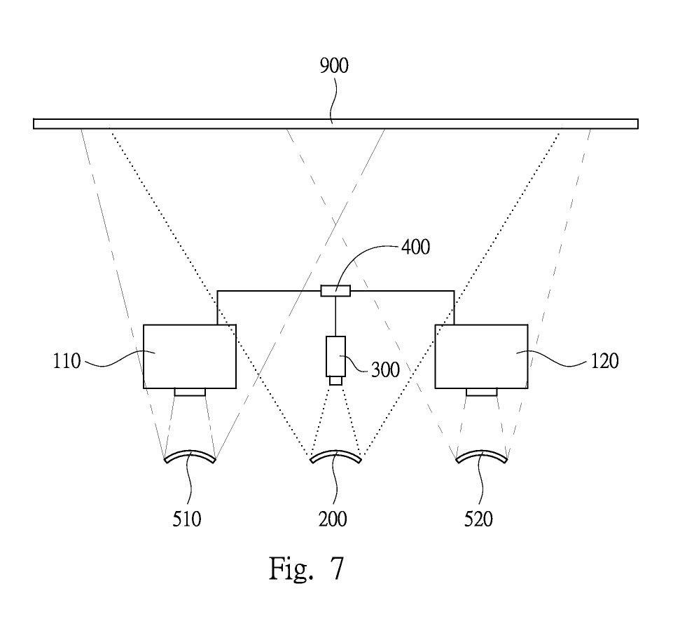

FIG. 6 is a schematic diagram of a display apparatus according to a third embodiment of the present invention, and FIG. 7 is a top view of the display apparatus of FIG. 6. Reference is made to FIG. 6 and FIG. 7. The display apparatus in this embodiment includes two projectors 110 and 120, an aspherical mirror 200, an image capture device 300, and an image correction system 400. Each of the projectors is configured to provide a sub image, that is, the projector 110 is configured to provide the sub image S1, and the projector 120 is configured to provide the sub image S2. The sub images S1 and S2 are projected onto the screen 900 to form a main image MI on the screen 900. The sub images S1 and S2 on the screen 900 are adjacent to each other and have an overlapping portion O. The image capture device 300 is disposed between the projectors 110 and 120, and is configured to capture a mirror image M3 on the aspherical mirror 200, wherein the mirror image M3 originate from the sub images S1 and S2. In this embodiment, the aspherical mirror 200 is configured to reflect at least the overlapping portion O to the image capture device 300. The image correction system 400 is configured to correct pixel positions of the sub images S1 and S2 on the screen 900 according to the mirror image M3 captured by the image capture device 300. As to the correction details of the image correction system 400 are all the same as the embodiment shown in FIG. 3, and, therefore, these are not repeated hereinafter.

In this embodiment, the sub image S1 provided by the projector 110 and the sub image S2 provided by the projector 120 both are projected onto the screen 900. The sub images S1 and S2 form the main image MI with the overlapping portion O on the screen 900. No corrections have been made to the sub images S1 and S2 yet. In other words, discontinuous edges (not shown) may exist at the overlapping portion O. At least the overlapping portion O is reflected by the aspherical mirror 200 and forms the mirror image M3. To eliminate the discontinuous edges, the image capture device 300 captures the mirror image M3 on the aspherical mirror 200. The mirror image M3 captured by the image capture device 300 is then sent to the image correction system 400, and the image correction system 400 corrects the pixel positions of the sub images S1 and S2 on the screen 900 according to the mirror image M3, such that the sub images S1 and S2 can be aligned.

In this embodiment, the image capture device 300 captures the mirror image M3 on the aspherical mirror 200 rather than the main image MI on the screen 900, such that the image capture device 300 do not need to take a wide range image as the main image MI. Since the sizes of the mirror image M3 is much smaller than the main image MI, the image capture device 300 in this embodiment can be a camera with low cost, such as a web cam.

In one or more embodiments, the projectors 110 and 120 can be extreme short throw (EST) projectors, such that the display apparatus can further include two projecting mirrors 510 and 520 configured to respectively reflect the sub images 51 and S2 onto the screen 900. The projector 110 is disposed between the screen 900 and the projecting mirror 510, and the projector 120 is disposed between the screen 900 and the projecting mirror 520. The aspherical mirror 200 is disposed between the projecting mirrors 510 and 520. The sub image 51 provided by the projector 110 impinges on the projecting mirror 510 and is then reflected to the screen 900 by the projecting mirror 510. The sub image S2 provided by the projector 120 impinges on the projecting mirror 520 and is then reflected to the screen 900 by the projecting mirror 520.

In one or more embodiments, the shape of the aspherical mirror 200 is substantially the same as or similar to the shape of the projecting mirrors 510 and 520. In other words, the projecting mirrors 510 and 520 can be aspherical. In greater detail, the sub images 51 and S2 with near rectangular shaped on the screen 900 can be produced by the projecting mirrors 510 and 520, respectively, and the projecting mirrors 510 and 520 can further decrease the distortion of the sub images 51 and S2. The aspherical mirror 200 can be the same as or similar to the shape of the projecting mirrors 510 and 520 to capture the substantially same shape of the overlapping portion O on the screen 900, such that the pixel position corrections can be more precise.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display apparatus, comprising:
a plurality of projectors, each of which configured to provide a sub image, the sub images being projected onto a screen to form a main image on the screen, adjacent two of the sub images on the screen having an overlapping portion;
at least one aspherical mirror;
at least one image capture device configured to capture at least one mirror image on the aspherical mirror, wherein the mirror image originates from the sub images; and
an image correction system configured to correct pixel positions of the sub images on the screen according to the mirror image captured by the image capture device.

2. The display apparatus of claim 1, wherein a plurality of the aspherical mirrors are configured to respectively reflect the sub images onto the screen.

3. The display apparatus of claim 2, wherein each of the projector is disposed between the screen and at least one of the aspherical mirrors.

4. The display apparatus of claim 2, wherein the image capture device is disposed between two of the projectors, and the image capture device is configured to capture the mirror image on every aspherical mirror in sequence.

5. The display apparatus of claim 2, wherein a plurality of the image capture devices are configured to respectively capture the mirror images on the aspherical mirrors.

6. The display apparatus of claim 1, wherein the aspherical mirror is configured to reflect at least the overlapping portion to the image capture device.

7. The display apparatus of claim 6, further comprising:
a plurality of projecting mirrors configured to respectively reflect the sub images onto the screen.

8. The display apparatus of claim 7, wherein each of the projectors is disposed between the screen and one of the projecting mirrors.

9. The display apparatus of claim 7, wherein the shape of the aspherical mirror is substantially the same as the shape of each of the projecting mirrors.

10. The display apparatus of claim 7, wherein the aspherical mirror is disposed between two of the projecting mirrors.

11. The display apparatus of claim 6, wherein the image capture device is disposed between two of the projectors.

12. The display apparatus of claim 1, wherein the image capture device is a web cam.

13. A display method, comprising:
projecting a plurality of sub images onto a screen to form a main image on the screen, wherein adjacent two of the sub images on the screen have an overlapping portion;
capturing at least one mirror image on at least one aspherical mirror, wherein the mirror image originates from the sub images; and
correcting pixel positions of the sub images on the screen according to the mirror image.

14. The display method of claim 13, wherein the step of projecting the sub images onto the screen comprises:
respectively providing the sub images to a plurality of the aspherical mirrors; and
respectively reflecting the sub images onto the screen by the aspherical mirrors; and
wherein the step of capturing the mirror image comprises:
capturing the mirror image on every aspherical mirror in sequence.

15. The display method of claim 13, wherein the step of projecting the sub images onto the screen comprises:
respectively providing the sub images to a plurality of the aspherical mirrors; and
respectively reflecting the sub images onto the screen by the aspherical mirrors; and
wherein the step of capturing the mirror image comprises:
respectively capturing a plurality of the mirror images on the aspherical mirrors.

16. The display method of claim 13, wherein the step of capturing the mirror image comprises:
reflecting at least the overlapping portion to the image capture device by the aspherical mirror; and
capturing the mirror image on the aspherical mirror.
